(19) United States
(12) Patent Application Publication
(10) Pub. No.: US 2025/0281957 A1
(43) Pub. Date: Sep. 11, 2025

(54) COOLING DEVICE AND HEAT TREATMENT APPARATUS INCLUDING THE SAME

(71) Applicant: Noritake Co., Limited, Nagoya-shi (JP)

(72) Inventors: Hidenori Nakamura, Nagoya-shi (JP); Hideaki Ohi, Nagoya-shi (JP); Masaki Iida, Nagoya-shi (JP)

(73) Assignee: Noritake Co., Limited, Nagoya-shi (JP)

(21) Appl. No.: 19/071,061

(22) Filed: Mar. 5, 2025

(30) Foreign Application Priority Data
Mar. 6, 2024 (JP) 2024-033594

(51) Int. Cl. B21B 45/02; B21B 1/26

(52) U.S. Cl. CPC B21B 45/0209; B21B 1/26

(57) ABSTRACT

A cooling device includes a loading section, an unloading section, plural cooling rollers, and a pair of support plates. The pair of support plates supports the plural cooling rollers. The support plates in a pair are opposed to each other to sandwich a space in which the cooling rollers are arranged in a staggered manner. The pair of support plates includes bearings that support respective roller shafts of the plural cooling rollers. A conveyance route for the workpiece is set so as to bring a first surface of a workpiece into contact with a cooling roller displaced toward a first side and bring a second side of the workpiece into contact with a cooling roller displaced toward a second side, among the plural cooling rollers.

### CROSS REFERENCE TO RELATED APPLICATION

This application claims the benefit of priority to Japanese Patent Application No. 2024-033594 filed on Mar. 6, 2024, the entire contents of which are hereby incorporated herein by reference.

### BACKGROUND OF THE DISCLOSURE

The present disclosure relates to a cooling device and a heat treatment apparatus including the same.

Japanese Patent Publication No. 7285360 discloses a heat treatment apparatus that includes an unwinding unit, a heat treatment unit, a cooling unit, and a winding unit. The cooling unit is provided with plural cooling rollers. In the cooling unit, a strip-shaped workpiece is cooled and conveyed while being hung on the cooling rollers.

### SUMMARY

The present inventors intend to improve the workability of hanging a strip-shaped workpiece on plural cooling rollers.

A cooling device disclosed herein includes a loading section, an unloading section, a plurality of cooling rollers, and a pair of support plates. The loading section loads a strip-shaped workpiece. The unloading section unloads the workpiece. The pair of support plates supports the plurality of cooling rollers. The cooling rollers are arranged in a staggered manner while being aligned with each other in an axial direction, with positions thereof sequentially displaced along a height direction. The support plates in a pair are opposed to each other to sandwich a space in which the cooling rollers are arranged in the staggered manner. The pair of support plates includes bearings that support respective roller shafts of the plural cooling rollers. A conveyance route for the workpiece is set such that the workpiece is loaded from the loading section, sequentially hung around the plurality of cooling rollers along the height direction, and then unloaded from the unloading section. The conveyance route for the workpiece is set so as to bring a first surface of the workpiece into contact with a cooling roller displaced toward a first side and bring a second surface of the workpiece into contact with a cooling roller displaced toward a second side, among the plural cooling rollers. Such a cooling device improves the workability of hanging the strip-shaped workpiece on the plurality of cooling rollers.

### BRIEF DESCRIPTION OF THE DRAWINGS

FIG. 1 is a schematic diagram illustrating a heat treatment apparatus 10 and a cooling device 50.

FIG. 2 is a schematic diagram illustrating a support structure of cooling rollers 52.

FIG. 3 is a schematic diagram illustrating the support structure of the cooling rollers 52.

FIG. 4 is a schematic diagram illustrating a first support portion 56a.

### DETAILED DESCRIPTION OF THE EMBODIMENTS

One embodiment in the present disclosure will be described in detail below with reference to the drawings. In the following drawings, members and portions that have the same actions are denoted by the same symbols. The dimensional relationships (length, width, thickness, etc.) in each drawing do not reflect the actual dimensional relationships. The directions of up, down, left, right, front, and back are represented are represented by arrows U, D, L, R, F, and Rr, respectively, in the figures. Here, the directions of up, down, left, right, front, and back are only provided for convenience of explanation and do not limit the present disclosure unless otherwise specifically mentioned.

### Heat Treatment Apparatus 10

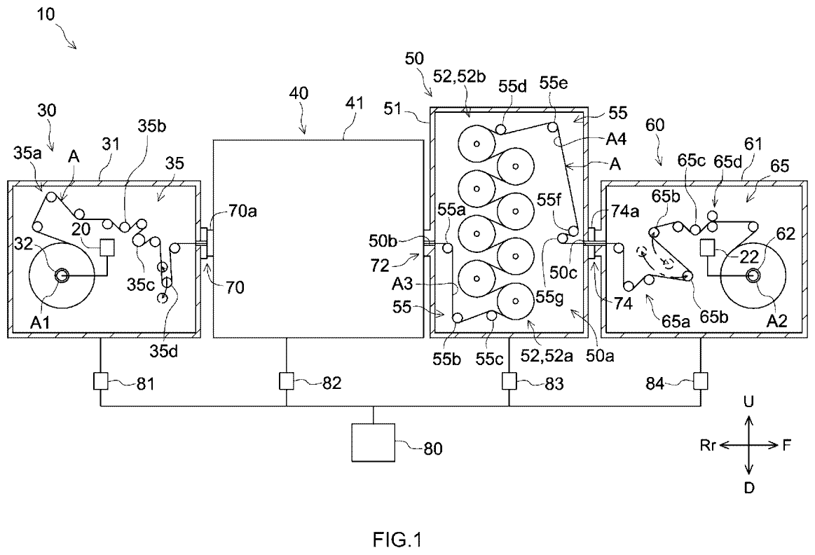

FIG. 1 is a schematic diagram illustrating a heat treatment apparatus 10 and a cooling device 50. The heat treatment apparatus 10 is equipment for performing heat treatment on a strip-shaped (sheet-shaped) workpiece A. In this embodiment, the heat treatment apparatus 10 is a device for continuously drying the strip-shaped workpiece while conveying it in a so-called roll-to-roll system. The workpiece A is not particularly limited as long as it is a strip-shaped object, such as an electrode sheet for secondary batteries that has an electrode material applied to both sides of a sheet base, a Flexible Copper Clad Laminate (FCCL), or a polyimide sheet. The heat treatment apparatus 10 can be used to process a variety of strip-shaped (sheet-shaped) workpieces.

As illustrated in FIG. 1, the heat treatment apparatus 10 includes an unwinding unit 30, a heat treatment unit 40, a cooling unit 50, and a winding unit 60. The heat treatment apparatus 10 includes conveyance devices 20 and 22. The cooling device 50 disclosed herein is used as the cooling unit 50 in the heat treatment apparatus 10. The strip-shaped workpiece A is conveyed and processed through the unwinding unit 30, the heat treatment unit 40, the cooling unit 50, and the winding unit 60 in that order. The workpiece A is unwound from an unwinding roll A1 provided in the unwinding unit 30, heat-treated in the heat treatment unit 40, cooled in the cooling unit 50, and then wound onto a winding roll A2 provided in the winding unit 60.

### Conveyance Devices 20 and 22

The conveyance devices 20 and 22 are devices that convey the workpiece A. The workpiece A is conveyed along a predetermined conveyance route. The conveyance devices 20 and 22 are devices that rotationally drive an unwinding shaft 32, on which the unwinding roll A1 of the unwinding unit 30 is attached, and a winding shaft 62, on which the winding roll A2 of the winding unit 60 is attached, respectively. In this embodiment, motors are used as the conveyance devices 20 and 22. Each of the conveyance devices 20 and 22 can be constituted of a device that controls the conveyance of the workpiece A. For example, a motor and an inverter may be used as the conveyance devices 20 and 22, and particularly a servo motor or the like may be used. The conveyance devices 20 and 22 may include a device that controls the tension applied to the workpiece A. For example, a powder clutch may be used as the device for controlling the tension. The conveyance devices 20 and 22 can be implemented using a set of devices where one controls the conveyance speed and another controls the tension, operating in cooperation with each other.

The unwinding shaft 32 is connected to the conveyance device 20. The unwinding shaft 32 is rotationally driven by the conveyance device 20, thereby unwinding the workpiece A from the unwinding roll A1. The winding shaft 62 is connected to the conveyance device 22. The winding shaft 62 is rotationally driven by the conveyance device 22, thereby winding the workpiece A onto the winding roll A2. The conveyance devices 20 and 22 may be installed in respective atmospheric boxes provided in spaces enclosed by outer walls 31 and 61, respectively. The conveyance devices 20 and 22 may be provided outside the outer walls 31 and 61, respectively. The heat treatment apparatus 10 can be configured to convey the workpiece A at a high speed in order to improve the processing efficiency of the workpiece A. Although not particularly limited, the conveyance speed of the workpiece A can be set to about 1 m/min to 200 m/min. In this embodiment, the conveyance speed of the workpiece A is set to about 100 m/min. In the heat treatment apparatus 10, the conveyance speed of the workpiece A is controlled by a controller (not illustrated).

The controller controls the conveyance speed of the workpiece A, the tension applied to the workpiece A, and the like such that the workpiece A is conveyed according to a predetermined conveyance condition. The controller respectively controls an unwinding tension applied when the workpiece A is unwound, an in-furnace tension applied to the workpiece A being processed, and a winding tension applied when the processed workpiece A is wound up. The controller is connected to the conveyance devices 20 and 22. The controller may be connected to a tension detection roller 35b, a feed roller 35c, a dancer roller 35d, a tension detection roller 65c, and the like. The controller feeds back the unwinding tension detected by the tension detection roller 35b to the conveyance device 20 and thereby controls the torque of the unwinding shaft 32. Thus, the unwinding tension is adjusted. The controller also feeds back, to the dancer roller 35d, the in-furnace tension detected by the tension detection roller 35b, over which the workpiece A being processed is hung. The dancer roller 35d moves according to the detected in-furnace tension. Thus, the in-furnace tension is adjusted. The rotation speed of the feed roller 35c is controlled such that the position of the dancer roller 35d returns to a reference position with the in-furnace tension being constant. The controller feeds back the winding tension detected by the tension detection roller 65c to the conveyance device 22 and thereby controls the torque of the winding shaft 62. Thus, the winding tension is adjusted.

### Unwinding Unit 30

The unwinding unit 30 is equipment that unwinds the workpiece A. The unwinding unit 30 houses the unwinding roll A1 in a state where the workpiece A before the heat treatment is wound thereon. The unwinding unit 30 has the outer wall 31 that encloses internal equipment and the unwinding roll A1. The unwinding unit 30 includes therein the unwinding shaft 32 and plural rollers 35. The unwinding shaft 32 is a shaft to which the unwinding roll A1, holding the workpiece A wound on it before heat treatment, is attached. In this embodiment, the unwinding shaft 32 is rotationally driven to unwind the workpiece A from the unwinding roll A1 attached to the unwinding shaft 32.

Within the space enclosed by the outer wall 31 of the unwinding unit 30, the plural rollers 35 that set the conveyance route for the workpiece A are provided. The workpiece A unwound from the unwinding roll A1 is hung around and sequentially passed through the plural rollers 35 in a predetermined order and then conveyed toward the heat treatment unit 40. The plural rollers 35 include guide rollers 35a, a tension detection roller 35b, a feed roller 35c, and a dancer roller 35d. The tension detection roller 35b is a roller for detecting the tension applied to the workpiece A. A tension detector (not illustrated) is attached to the tension detection roller 35b. The dancer roller 35d is configured to be movable within a predetermined range. By moving the dancer roller 35d, the tension applied to the workpiece A is adjusted. The feed roller 35c is rotationally driven by a drive device (not illustrated). By controlling the rotation of the feed roller 35c, the position of the dancer roller 35d is adjusted.

### Heat Treatment Unit 40

The heat treatment unit 40 is equipment where the strip-shaped workpiece A is heat-treated while being conveyed. The heat treatment unit 40 is connected to the unwinding unit 30 via a connecting part 70. The connecting part 70 is provided with an outlet for the unwinding unit 30 and an inlet for the heat treatment unit 40. A path through which the workpiece A passes is formed in the connecting part 70. The workpiece A is conveyed from the unwinding unit 30 to the heat treatment unit 40 through the connecting part 70. The path for the workpiece A formed in the connecting part 70 is set to have dimensions slightly larger than the width and thickness of the workpiece A. This reduces the likelihood of interference between the atmosphere of the heat treatment unit 40 and that of the unwinding unit 30.

Although a detailed illustration thereof is omitted, the heat treatment unit 40 may include an outer wall 41, a heater, and guide rollers. The heat treatment unit 40 has therein a processing space where the unwound workpiece A is heat-treated while being conveyed. The outer wall 41 encloses the processing space in which the heater and the guide rollers are disposed.

The conveyance route along which the workpiece A is conveyed is set by the guide rollers. The guide roller is configured to rotate in a driven manner as the workpiece A is conveyed.

The heater is equipment for heating the workpiece A. The workpiece A is heat-treated by the heater while being conveyed in the conveyance route set by the guide rollers. Note that the configuration of the heat treatment unit 40, including the guide rollers, the heater, and the like, is not particularly limited. The heat-treated workpiece A is conveyed out toward the cooling unit 50.

### Cooling unit 50

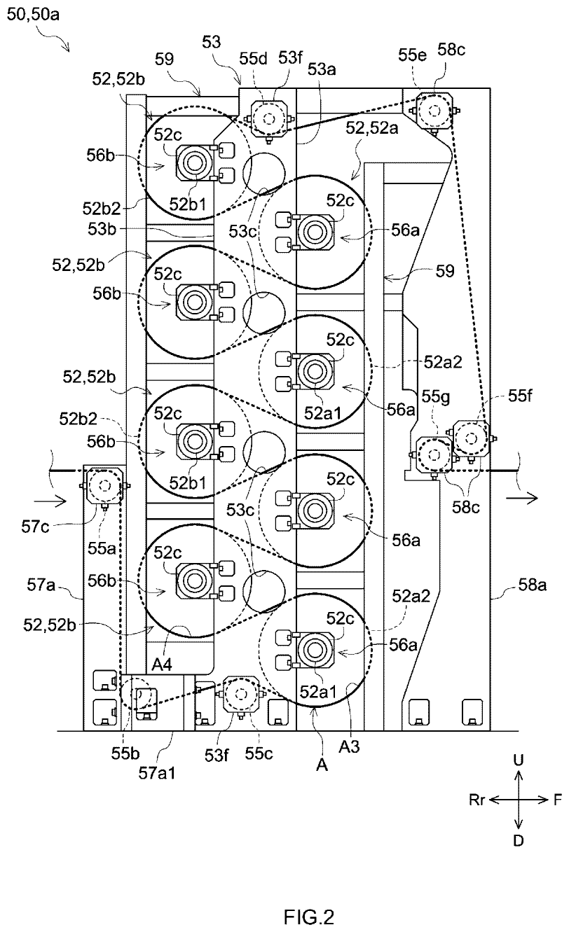

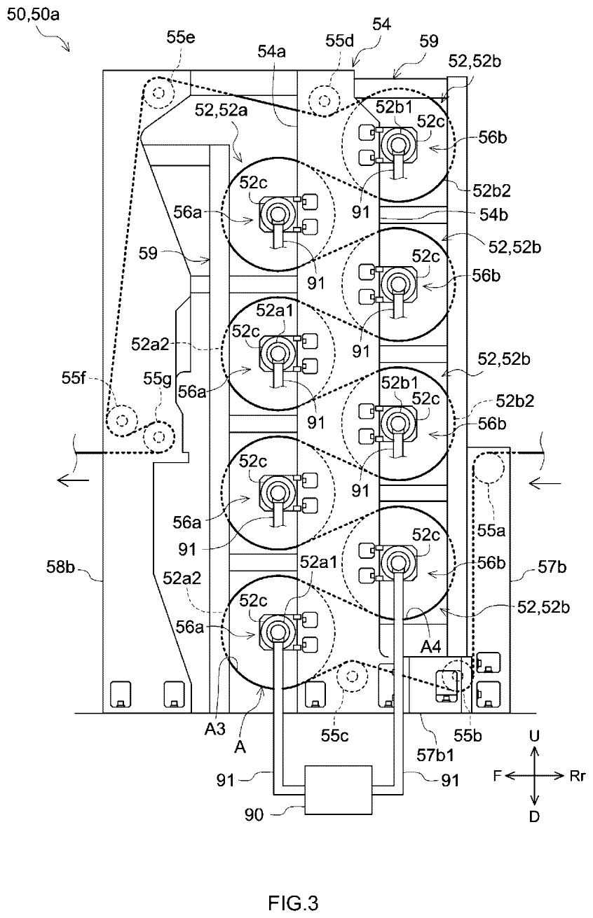

The cooling unit 50 is equipment in which the workpiece A heat-treated in the heat treatment unit 40 is cooled while being conveyed. The cooling unit 50 is connected to the heat treatment unit 40 via a connecting part 72. The cooling unit 50 includes a loading section 50b, an unloading section 50c, plural cooling rollers 52, and a pair of support plates 53 and 54 (see FIGS. 2 and 3). The cooling unit 50 also includes plural guide rollers 55 and an outer wall 51.

The strip-shaped workpiece A is loaded from the loading section 50b. The loading section 50b is provided in the connecting part 72. The workpiece A is unloaded from the unloading section 50c. The unloading section 50c is provided in a connecting part 74. The loading section 50b and the unloading section 50c are positioned to be opposed to each other. The positional relationship between the loading section 50b and the unloading section 50c is not particularly limited. In the connecting part 72, like the connecting part 70, a passageway is formed through which the workpiece A passes. The configuration of the connecting part 72 can be the same as that of the connecting part 70, and thus a detailed description thereof is omitted.

### Cooling Roller 52

The cooling roller 52 is a roller configured to allow a refrigerant to circulate therein. The workpiece A is cooled by contacting a surface of the cooling roller 52. The cooling rollers 52 include a first cooling roller 52a and a second cooling roller 52b. The first cooling roller 52a is the cooling roller 52 around which the workpiece A is hung so as to bring its first surface A3 into contact with the roller. The second cooling roller 52b is the cooling roller 52 around which the workpiece A is hung so as to bring its second surface A4 into contact with the roller. In this embodiment, each cooling roller 52 is connected to a drive device (not illustrated). The cooling roller 52 rotates along the conveyance direction at a set conveyance speed. In this embodiment, the workpiece A is cooled to about room temperature in the cooling unit 50. The temperature of the workpiece A to be cooled is not particularly limited.

Plural first cooling rollers 52a (four in this embodiment) are provided. In addition, plural second cooling rollers 52b (four in this embodiment) are also provided. The number of cooling rollers 52 is not particularly limited. However, for example, one first cooling roller 52a and one second cooling roller 52b may be provided.

The plural first cooling rollers 52a are arranged in a row at a predetermined pitch along the height direction at the front (outlet side) of the cooling unit 50. The plural second cooling rollers 52b are arranged in a row at a predetermined pitch along the height direction at the rear (loading section 50b side) of the cooling unit 50. A spacing between adjacent first cooling rollers 52a and a spacing between adjacent second cooling rollers 52b are each set to be narrower than an outer diameter of the cooling roller 52. The arrangement of the first cooling rollers 52a and the second cooling rollers 52b is not particularly limited.

Here, the first cooling rollers 52a and the second cooling rollers 52b are arranged at the same pitch. The second cooling roller 52b is sequentially positioned by half a pitch higher than the first cooling roller 52a, as viewed from the bottom. Thus, the plural first cooling rollers 52a and the plural second cooling rollers 52b are arranged such that their heights are differentiated sequentially at the front and rear of the cooling unit 50. In other words, the plural first cooling rollers 52a and the plural second cooling rollers 52b are arranged in a staggered manner. This allows the cooling unit 50 to have a structure elongated in the height direction. On the other hand, an exclusive area of the cooling unit 50 can be reduced to save space in a facility.

The outer wall 51 encloses a processing space 50a in which the plural cooling rollers 52 and the plural guide rollers 55 are disposed. In this embodiment, the plural cooling rollers 52 are provided in the cooling unit 50. The plural cooling rollers 52 and the plural guide rollers 55 set the conveyance route along which the workpiece A is conveyed within the cooling unit 50.

### Guide Rollers 55

The guide rollers 55 (55a to 55g) are rollers that guide the workpiece A. In this embodiment, each guide roller 55 is a substantially cylindrical roller. In the cooling unit 50, the conveyance route for the workpiece A is set by the plural guide rollers 55 such that it is directed from the loading section 50b (connecting part 72) toward the outlet (connecting part 74) through the plural cooling rollers 52. Among the plural guide rollers 55, the guide roller 55b is a tension detection roller that detects the tension applied to the workpiece A.

The guide roller 55a is disposed such that its uppermost portion is at the same height as the loading section 50b of the cooling unit 50. The guide rollers 55b and 55c are disposed in a lower portion of the cooling unit 50. The guide roller 55b is disposed below the guide roller 55a. The guide roller 55c is disposed in front of the guide roller 55b (on the right side in the figure). The guide rollers 55d and 55e are disposed in an upper portion of the cooling unit 50. The guide roller 55d is disposed above the guide roller 55c. The guide roller 55e is disposed in front of the guide roller 55d. The guide rollers 55f and 55g are disposed near the unloading section 50c of the cooling unit 50. The guide roller 55g is disposed such that its lowermost portion is at the same height as the unloading section 50c of the cooling unit 50. The lowermost portion of the guide roller 55g is substantially at the same height as the uppermost portion of the guide roller 55a. The guide roller 55f is positioned higher by one guide roller 55 than the guide roller 55g. The guide roller 55f is positioned between the guide roller 55g and the unloading section 50cof the cooling unit 50.

The workpiece A is introduced into the cooling unit 50 from the loading section 50b of the cooling unit 50 through the guide roller 55a. The workpiece A is conveyed substantially horizontally to the cooling unit 50. The workpiece A is hung on the guide roller 55a from above and conveyed downward. The workpiece A is hung on the guide roller 55b from the left side and conveyed forward. The workpiece A is hung on the guide roller 55c from above and conveyed to the first cooling roller 52a disposed at the lowermost end. The workpiece A is then alternately hung around the first cooling rollers 52a and the second cooling rollers 52b in sequence from the bottom and is conveyed from the second cooling roller 52b, which is located at the uppermost end, toward the guide roller 55d. The workpiece A is hung on the guide roller 55d from below and conveyed forward. The workpiece A is hung on the guide roller 55e from above and conveyed downward. The workpiece A is hung on the guide roller 55f from the right side and conveyed rearward. The workpiece A is hung on the guide roller 55g from above and then folded back forward. The workpiece A is conveyed substantially horizontally toward the unloading section 50c of the cooling unit 50.

The cooling unit 50 is connected to the winding unit 60 via the connecting part 74. The connecting part 74 includes the unloading section 50c for the cooling unit 50 and an inlet for the winding unit 60. The cooled workpiece A is conveyed to the winding unit 60 through the connecting part 74.

### Winding Unit 60

The winding unit 60 is equipment that winds up the workpiece A. The winding unit 60 houses the winding roll A2 for winding up the workpiece A that has been cooled through the cooling unit 50. The winding unit 60 includes the outer wall 61 surrounding internal equipment and the winding roll A2. The winding unit 60 is provided with the winding shaft 62 and plural rollers 65. The winding roll A2 is attached to the winding shaft 62, and the workpiece A, which has been heat-treated in the heat treatment unit 40 and cooled in the cooling unit 50, is wound onto the winding roll A2. By rotationally driving the winding shaft 62, the workpiece A is wound onto the winding roll A2.

Within the space enclosed by the outer wall 61 of the winding unit 60, the plural rollers 65 that set the conveyance route for the workpiece A are provided. The plural rollers 65 set the conveyance route along which the workpiece A is conveyed within the winding unit 60. The workpiece A conveyed from the cooling unit 50 is hung over the roller 65 near the inlet (connecting part 74) of the winding unit 60, then hung around the plural rollers 65 in the predetermined order, and eventually wound onto the winding roll A2. The plural rollers 65 include guide rollers 65a, a dancer roller 65b, the tension detection roller 65c, and feed rollers 65d. The dancer roller 65b is configured to be movable within a predetermined range. The dancer roller 65b can be moved, for example, to secure a necessary extra length of the workpiece A when the winding roll A2 is replaced. A tension detector (not illustrated) is attached to the tension detection roller 65c. The feed roller 65d feeds out the necessary extra length of the workpiece A when the workpiece A is attached to a new winding roll A2 after the replacement of the winding roll A2.

### Vacuum Pump 80

The heat treatment apparatus 10 includes a vacuum pump 80. Interior spaces of the unwinding unit 30, the heat treatment unit 40, the cooling unit 50, and the winding unit 60 described above are enclosed by the outer walls 31, 41, 51, and 61, respectively. The unwinding unit 30, the heat treatment unit 40, the cooling unit 50, and the winding unit 60 have the spaces isolated from an external space by the outer walls 31, 41, 51, and 61, respectively. The interior spaces of the outer walls 31, 41, 51, and 61 communicate with each other when the workpiece A is treated. The vacuum pump 80 is connected to the outer walls 31, 41, 51, and 61 of the respective units. The vacuum pump 80 reduces the pressure in the interior spaces of the unwinding unit 30, the heat treatment unit 40, the cooling unit 50 (processing space 50a in the cooling unit 50), and the winding unit 60. In this embodiment, the workpiece A is processed under a predetermined vacuum atmosphere with a pressure lower than atmospheric pressure.

The connection form of the vacuum pump 80 is not particularly limited. Plural vacuum pumps 80 may be provided. The respective vacuum pumps 80 may be connected to the unwinding unit 30, the heat treatment unit 40, the cooling unit 50, and the winding unit 60. Alternatively, pipes may be branched from one vacuum pump 80 to reduce the pressure inside some of the unwinding unit 30, the heat treatment unit 40, the cooling unit 50, and the winding unit 60.

The pipe of the vacuum pump 80 is provided with vacuum valves 81 to 84 for adjusting the vacuum level in each unit. The vacuum valves 81 to 84 are configured to be switchable between the connection of each unit to the vacuum pump 80 and the disconnection of each unit from the vacuum pump 80. In a case where the vacuum level of each unit is not adjusted, open/close valves may be used instead of the vacuum valves 81 to 84.

A door 70a is provided at the inlet of the heat treatment unit 40 (in this embodiment, the connecting part 70). The door 70a is closed when the unwinding roll A1 is replaced, for example. By closing the door 70a when replacing the unwinding roll A1 or the like, the atmosphere of the heat treatment unit 40 (in this embodiment, a reduced pressure state) can be maintained. The door 70a may be closed when the workpiece A passes through the connecting part 70, such as when the unwinding roll A1 is replaced. When the remaining workpiece A wound on the unwinding roll A1 is nearly depleted, the unwinding roll A1 is replaced with a new one. An end of a workpiece A on a newly installed unwinding roll A1 after the replacement is joined to the end of the workpiece A from the previous roll before the replacement. With the workpiece A remaining in the processing space, the unwinding roll A1 can be replaced while maintaining the atmosphere in the heat treatment unit 40, allowing for a quick recovery of the apparatus after the replacement of the unwinding roll A1.

A door 74a is provided at the unloading section 50c of the cooling unit 50 (in this embodiment, the connecting part 74). Like the door 70a, the door 74a can maintain the atmosphere (in this embodiment, the reduced pressure state) in the cooling unit 50 by closing the door 74a when replacing the winding roll A2 or the like. The door 74a may be closed when the workpiece A passes through the connecting part 74, such as when the winding roll A2 is replaced. When the amount of the workpiece A wound on the winding roll A2 becomes significant, the winding roll A2 is replaced with a new one. A leading edge of the newly installed winding roll A2 after the replacement and the end of the workpiece A are joined together. With the workpiece A remaining in the processing space 50a, the winding roll A2 can be replaced while maintaining the atmosphere in the cooling unit 50, allowing for a quick recovery of the apparatus after the replacement of the winding roll A2.

In the cooling device, a strip-shaped workpiece is cooled while being conveyed along the set conveyance route. The conveyance route is set to be aligned with the plural cooling rollers. The workpiece is loaded from the loading section, hung around the plural cooling rollers, and then unloaded from the unloading section. In the cooling device, the strip-shaped workpiece is cooled by contacting the cooling rollers. When processing the workpiece using such a cooling device, the workpiece is loaded from the loading section, passed between the plural cooling rollers, and discharged through the unloading section in advance, while the cooling device remains stopped. Thereafter, the cooling device is actuated, thereby allowing the workpiece to be cooled while being conveyed. The present inventors intend to improve the workability of causing the workpiece to pass through the plural cooling rollers.

FIGS. 2 and 3 are schematic diagrams, each illustrating a support structure of the cooling rollers 52. In FIG. 2, the support structure of the cooling rollers 52 is illustrated as viewed from the right side. In FIG. 3, the support structure of the cooling rollers 52 is illustrated as viewed from the left side.

### Plural Cooling Roller 52

The plural cooling rollers 52 (first cooling rollers 52a and second cooling rollers 52b) include roller shafts 52a1 and 52b1 and roller bodies 52a2 and 52b2, respectively, as illustrated in FIGS. 2 and 3. The roller shafts 52a1 and 52b1 are substantially cylindrical shaft-shaped members. Each of the roller shafts 52a1 and 52b1 is a member that serves as the rotation axis of the corresponding cooling roller 52. The roller shafts 52a1 and 52b1 of the cooling rollers 52 extend in the direction (left-right direction) in which the support plates 53 and 54 in a pair are opposed to each other. Thus, the axial directions of the plural cooling rollers 52 are aligned with one another. The roller shafts 52a1 and 52b1 are supported by the pair of support plates 53 and 54 via respective bearings 52c.

The roller bodies 52a2 and 52b2 are attached to the roller shafts 52a1 and 52b1, respectively. The roller bodies 52a2 and 52b2 are members with a substantially cylindrical shape, each having a diameter larger than that of its corresponding roller shaft 52a1 or 52b1. The roller bodies 52a2 and 52b2 are parts that the workpiece A contacts. Within each of the roller bodies 52a2 and 52b2, a route is provided to allow the refrigerant to pass therethrough. The route through which the refrigerant passes is joined from the roller shafts 52a1 and 52b1 to the roller bodies 52a2 and 52b2. The roller bodies 52a2 and 52b2 are cooled by supplying the refrigerant to the roller bodies 52a2 and 52b2. The workpiece A is cooled by coming into contact with the cooled roller bodies 52a2 and 52b2 during conveyance.

The plural cooling rollers 52 are arranged in a staggered manner, with their positions sequentially displaced along the height direction. Here, of the plural cooling rollers 52, the first cooling rollers 52a are disposed at the first side (front) of the support plates 53 and 54. Of the plural cooling rollers 52, the second cooling rollers 52b are disposed on the second (rear) side of the support plates 53 and 54. The first cooling roller 52a and the second cooling roller 52b are alternately arranged along the height direction.

The conveyance route for the workpiece A is set such that the workpiece A is loaded from the loading section 50b (see FIG. 1), sequentially hung around the plural cooling rollers 52, and then unloaded from the unloading section 50c (see FIG. 1). In the conveyance route for the workpiece A, the hanging of the workpiece A is performed so as to bring the first surface A3 of the workpiece A into contact with the cooling roller (first cooling roller 52a) displaced toward the first side and bring the second surface A4 into contact with the cooling roller (second cooling roller 52b) displaced toward the second side, among the plurality of cooling rollers 52. The workpiece A is alternately hung around the first cooling roller 52a and the second cooling roller 52b. This increases the length of contact between the workpiece A and the cooling rollers 52, allowing the workpiece A to be cooled efficiently. The plural cooling rollers 52 are supported by the pair of support plates 53 and 54.

### Pair of Support Parts 53 and 54

The support plates 53 and 54 in the pair are opposed to each other. The pair of support plates 53 and 54 is provided in the processing space 50a isolated from the outside of the outer wall 51 (see FIG. 1). The support plates 53 and 54 in the pair are opposed to each other in the axial direction (left-right direction) of the cooling roller 52. In the processing space 50a, the support plate 53 is provided on the right side, while the support plate 54 is provided on the left side. The support plates 53 and 54 in the pair sandwich a space in which the plural cooling rollers 52 are arranged in the staggered manner. In this embodiment, the support plates 53 and 54 in the pair sandwich the space in which the roller bodies 52a2 and 52b2 are arranged. The pair of support plates 53 and 54 includes the bearings 52c that support the respective roller shafts 52a1 and 52b1 of the plural cooling rollers 52.

The pair of support plates 53 and 54 extends along their height direction. The pair of support plates 53 and 54 extends in the height direction up to a position higher than the roller axis 52b1 of the cooling roller 52, which is disposed at the highest point among the plural cooling rollers 52. The widths (dimensions in the front-back direction) of the support plates 53 and 54 in the pair are set such that the side surfaces of the plural roller bodies 52a2 and 52b2 are exposed from the pair of support plates 53 and 54 when viewed along the axial direction. In this embodiment, the width of each of the pair of support plates 53 and 54 is narrower than a distance between a position where the roller shaft 52a1 of the first cooling roller 52a is arranged in the height direction and a position where the roller shaft 52b1 of the second cooling roller 52b is arranged in the height direction.

However, the material of the support plates 53 and 54 is not particularly limited. The support plates 53 and 54 can be formed using a stainless steel plate, for example. The thickness and material of the support plates 53 and 54 may be set according to the weight of the plural cooling rollers 52, the tension applied to the workpiece A during conveyance, and the like.

### Support Plate 53

The support plate 53 supports right end portions of the cooling rollers 52. As illustrated in FIG. 2, through holes 53c are formed in the support plate 53. The shape of the through hole 53c is substantially circular. The shape of the through hole 53c is not particularly limited and may be polygonal or elliptical. From the viewpoint of the strength of the support plate 53, the through hole 53c preferably has a substantially circular shape. The through hole 53c is a working through hole used by workers to perform tasks with their hands or tools during the operation of hanging the workpiece A around the cooling roller 52 (feed work), both before and after the processing of the workpiece A. The dimensions of the through hole 53c may be set in consideration of the strength of the support plate 53. The through hole 53c may be set to a dimension that is not too large so that the support plate 53 can withstand the tension applied to the workpiece A during conveyance. Although not particularly limited, the dimension of the through hole 53c may be between about 10 cm and about 30 cm, inclusive.

The through holes 53c are formed in the same number as the number of the first cooling rollers 52a and also as the number of the second cooling rollers 52b. Each of the through holes 53c is formed substantially at a center portion of the support plate 53 in the width direction (front-back direction) of the support plate 53. The through holes 53c are formed slightly closer to a side surface 53a on the first side. The through holes 53c are formed at positions overlapping the conveyance route for the workpiece A in the direction in which the support plates 53 and 54 in the pair (see FIGS. 2 and 3) are opposed to each other. Here, each through hole 53c is provided at a position overlapping the workpiece A, which is hung from the first cooling roller 52a to the second cooling roller 52b. The workpiece A hung from the first cooling roller 52a to the second cooling roller 52b overlaps a lower portion of the through hole 53c.

The support plate 53 has support portions 56a and 56b (first support portions 56a and second support portions 56b) as illustrated in FIG. 2. The support portions 56a and 56b are members that support the cooling rollers 52. The support portions 56a and 56b are provided with the bearings 52c. The first support portions 56a are provided at the side surface 53a on the first side. The first support portion 56a supports the corresponding first cooling roller 52a. The second support portions 56b are provided at a side surface 53b on the second side. The second support portion 56b supports the corresponding second cooling roller 52b. The side surface 53a on the first side faces forward. The side surface 53b on the second side faces rearward. Each of the side surface 53a on the first side and the side surface 53b on the second side is a flat surface and has a substantially rectangular shape that is longer in the height direction than in the thickness direction (opposed direction).

The first support portions 56a and the second support portions 56b protrude from the side surface 53a on the first side and the side surface 53b on the second side, respectively, of the support plate 53. Thus, the bearings 52c support the cooling rollers 52 in front of and behind the support plate 53. The first support portion 56a protrudes forward relative to the side surface 53a on the first side. The second support portion 56b protrudes rearward relative to the side surface 53b on the second side.

The first support portions 56a and the second support portions 56b may be integrally configured with the support plate 53. The first support portion 56a and the second support portion 56b may be members that are different from the support plate 53 and may be attached to the support plate 53. In this embodiment, the first support portion 56a and the second support portion 56b are separate members from the support plate 53 and are attached to the support plate 53. The first support portion 56a is attached to the side surface 53a on the first side of the support plate 53. The second support portion 56b is attached to the side surface 53b on the second side of the support plate 53. Hereinafter, the attachment structure of the first support portions 56a to the support plate 53 will be described. Since the attachment structure of the second support portions 56b to the support plate 53 is the same as that of the first support portions 56a thereto, a detailed description thereof is omitted.

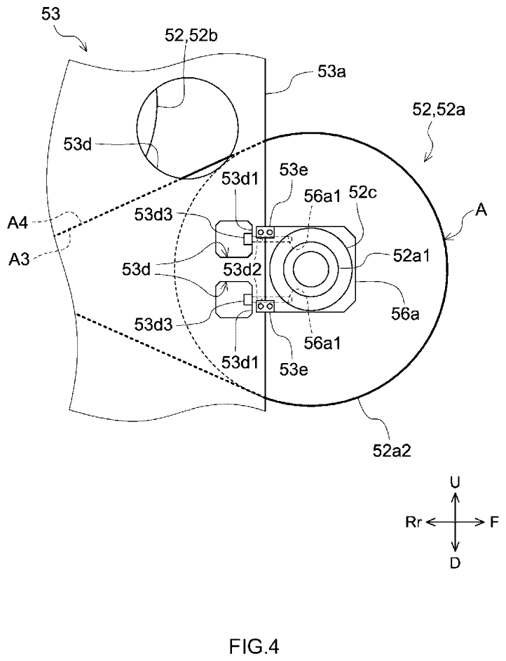

FIG. 4 is a schematic diagram illustrating the first support portion 56a. FIG. 4 illustrates the attachment structure of the support plate 53 and the support portions 56a that support the first cooling rollers 52a. Each of the first support portions 56a is a plate-shaped member with the substantially same thickness as the support plate 53.

As illustrated in FIG. 4, second through holes 53d are formed in the support plate 53. The second through hole 53d penetrates the support plate 53 in its thickness direction. The second through hole 53d has a smaller diameter than the through hole 53c. The second through hole 53d is provided in proximity to a position where the first support portion 56a is provided. The second through hole 53d is provided in proximity to the side surface 53a on the first side. Two second through holes 53d are provided in upper and lower positions of one first support portion 56a, with one second through hole at each position. The upper second through hole 53d is provided at a height corresponding to an upper portion of the first support portion 56a. The lower second through hole 53d is provided at a height corresponding to a lower portion of the first support portion 56a.

The second through hole 53d has a substantially rectangular shape with chamfered corners. A third through hole 53d2 is formed from a surface 53d1 closer to the first support portion 56a among the inner circumferential surfaces of the second through hole 53d, toward the side surface 53a on the first side of the support plate 53. Attachment holes 56a1 are formed in the support portion 56a. Two of the attachment holes 56a1 are formed in positions corresponding to the upper and lower third through holes 53d2.

Each first support portion 56a is attached to the support plate 53 by attachment members 53d3. For example, a bolt or the like can be used as the attachment member 53d3. The attachment member 53d3 is inserted into the third through hole 53d2. The attachment member 53d3 penetrates from the inner circumferential surface of the second through hole 53d toward the side surface 53a on the first side and is attached to the attachment hole 56a1. The attachment hole 56a1 can be, for example, a bolt hole into which the attachment member 53d3 fits. The first support portion 56a has its two portions, i.e., its upper and lower portions attached to the support plate 53. This allows the first support portion 56a to be stably attached to the support plate 53.

The first support portion 56a and the support plate 53 may be reinforced by a reinforcing plate 53e. The reinforcing plate 53e is a substantially rectangular stainless steel plate attached across the first support portion 56a and the support plate 53. The material, shape, and the like of the reinforcing plate 53e are not particularly limited. The reinforcing plate 53e is attached to outer surfaces of the first support portion 56a and support plate 53. The reinforcing plates 53e join the respective upper and lower portions of the first support portion 56a to the support plate 53. The provision of the reinforcing plate 53e allows the first support portion 56a to be stably attached to the support plate 53. Furthermore, the provision of the reinforcing plate 53e also enhances the ability to withstand loads that may be applied to the cooling roller 52 in its axial direction during the processing of the workpiece A or the like.

In the embodiment described above, the cooling device 50 has the loading section 50b (see FIG. 1), the unloading section 50c (see FIG. 1), the plural cooling rollers 52, and the pair of support plates 53 and 54. The loading section 50b loads the workpiece A. The unloading section 50c unloads the workpiece A. As illustrated in FIGS. 2 and 3, the support plates 53 and 54 support the plural cooling rollers 52. The plural cooling rollers 52 are arranged in the staggered manner while being aligned with one another in the axial direction, with their positions sequentially displaced along the height direction. The support plates 53 and 54 in the pair sandwich the space in which the cooling rollers 52 are arranged in the staggered manner. The support plates 53 and 54 each include the bearings 52c that support the respective roller shafts 52a1 and 52b1 of the plural cooling rollers 52. The conveyance route for the workpiece A is set such that the workpiece A is loaded from the loading section 50b, sequentially hung around the plural cooling rollers 52 along the height direction, and then unloaded from the unloading section 50c. In addition, the conveyance route for the workpiece A is set so as to bring the first surface A3 of the workpiece A into contact with the cooling roller 52a displaced toward the first side and bring the second surface A4 of the workpiece A into contact with the cooling roller 52b displaced toward the second side, among the plurality of cooling rollers 52.

In the cooling device 50, the conveyance route for the workpiece A is set such that the workpiece A is hung around the plural cooling rollers 52, which are arranged in the staggered manner along the height direction. The workpiece A is sequentially hung around the plural cooling rollers 52 arranged in the staggered manner along the height direction. It is necessary to sequentially hang the workpiece A on the plural cooling rollers 52 before processing the workpiece A. The cooling rollers 52 are arranged in the space sandwiched between the support plates 53 and 54 in the pair. Thus, when sequentially hanging the workpiece A on the cooling rollers 52, the workpiece A can be hung on the plural cooling rollers 52 by alternately passing the workpiece A from the outside (front and rear) of the pair of support plates 53 and 54 toward the front side and rear side.

In the embodiment described above, as illustrated in FIG. 2, the through holes 53c are formed in the support plate 53 of the pair of support plates 53 and 54. This enables workers to perform an operation of hanging the workpiece A around the cooling rollers 52 with their hands or tools through the through holes 53c. As the workpiece A can be easily passed between the cooling rollers 52, the workability of hanging the workpiece A on the cooling rollers 52 is improved. In addition, the support plate 53 can be made lighter, thus reducing the weight of the entire device.

The through holes 53c are formed at positions overlapping the conveyance route for the workpiece A in the direction in which the support plates 53 and 54 in the pair are opposed to each other. This makes it easier to access the workpiece A through the through hole 53c. Thus, the workability of hanging the workpiece A on the plural cooling rollers 52 can be improved.

In the embodiment described above, each through hole 53c is provided substantially at the center portion of the supply plate 53. This can improve the workability of passing the workpiece A both when passing the workpiece A from the front cooling roller 52 (in this embodiment, the first cooling roller 52a) to the rear cooling roller 52 (in this embodiment, the second cooling roller 52) and when passing the workpiece A from the rear cooling roller 52 to the front cooling roller 52.

However, the through holes 53c are formed in one of the pair of support plates 53 and 54 (in this embodiment, the support plate 53 on the right side), but the through hole 53c is not limited to such a form. The through hole may also be formed on the other support plate 54.

In the embodiment described above, the support plate 53 includes the support portions 56a and 56b that support the plural cooling rollers 52 at the side surface 53a on the first side and the side surface 53b on the second side, while the support plate 54 includes the support portions 56a and 56b that support the plural cooling rollers 52 on a side surface 54a on the first side and a side surface 54b on the second side. The provision of the support portions 56a and 56b at the side surfaces 53a and 53b make it easier for the cooling rollers 52 to be detached from the side surfaces 53a and 53b of the support plate 53. Thus, the workability of hanging the workpiece A on the plural cooling rollers 52 can be improved.

In the embodiment described above, the support portions 56a and 56b protrude from the side surfaces 53a and 54a on the first side and the side surfaces 53b and 54b on the second side, of the pair of support plates 53 and 54, respectively. Consequently, an area where the cooling rollers 52 overlap the support plate 53 in the axial direction of the cooling roller 52 becomes smaller. As a result, the workability of hanging the workpiece A on the plural cooling rollers 52 can be improved.

In the embodiment described above, the support plate 53 has the second through holes 53d formed in proximity to the positions where the support portions 56a and 56b are provided. The support portions 56a and 56b are attached to the support plate 53 by the attachment member 53d3 that penetrates from the inner circumferential surface of the second through hole 53d toward the closer of the side surface 53a on the first side or the side surface 53b on the second side. Thus, when attaching and detaching the support portions 56a and 56b and the cooling rollers 52, it is easy to work from the outside of the support plate 53 (here, from the right side). As a result, maintainability of the cooling rollers 52, including replacement, inspection, etc., can be improved.

In this embodiment, the through holes 53c are formed in the support plate 53 of the pair of support plates 53 and 54. As illustrated in FIG. 3, the support plate 54 is provided with a refrigerant pipe 91 through which a refrigerant is supplied to the cooling roller 52.

### Support Plate 54

The support plate 54 supports left end portions of the cooling rollers 52. Like the support plate 53, the support plate 54 includes support portions 56a and 56b (first support portions 56a and second support portions 56b) that support the plural cooling rollers 52 at the side surface 54a on the first side and at the side surface 54b on the second side, respectively. The configuration of each of the support portions 56a and 56b is the same as that of the support plate 53 described above, and thus a detailed description thereof is omitted.

Although a detailed illustration is omitted, the refrigerant pipe 91 is joined to each of the ends of the roller shafts 52a1 and 52b1. The refrigerant pipes 91 are connected to a refrigerant supply device 90. The refrigerant supply device 90 supplies the refrigerant toward the refrigerant pipes 91. The refrigerant is supplied from the roller shafts 52a1 and 52b1 to the roller bodies 52a2 and 52b2, respectively. Each of the cooling rollers 52 is connected to the refrigerant pipe 91.

In this embodiment, the cooling roller 52 has a so-called double-tube structure. The double-tube structure is formed at each of the ends of the roller shafts 52a1 and 52b1. In the cooling rollers 52, the refrigerant flows in and out from the left ends of the roller shafts 52a1 and 52b1. Each of the roller shafts 52a1 and 52b1 has inner and outer tubes. The refrigerant flows in from the refrigerant pipes 91 connected to the left ends of the roller shafts 52a1 and 52b1, passes between the outer and inner tubes of each of the roller shafts 52a1 and 52b1, passes through the roller bodies 52a2 and 52b2, passes through the inner tube of each of the roller shafts 52a1 and 52b1, and flows out from the refrigerant pipes 91. The refrigerant pipe 91 may include an inflow pipe that allows the refrigerant to flow into the cooling roller 52 and an outflow pipe that allows the refrigerant to flow out of the cooling roller 52. However, the configuration of the cooling roller 52 is not limited to the form described above. For example, the flow path for the refrigerant may be set such that the refrigerant circulates among some of the plural cooling rollers 52.

Of the pair of support plates 53 and 54, one support plate 53 is provided with the through holes 53c (see FIG. 2). The other support plate 54 is provided with the refrigerant pipes 91 through which the refrigerant is supplied to the cooling rollers 52. Since the through hole 53c is provided in the support plate 53, which is positioned on the side opposite to the refrigerant pipe 91, the refrigerant pipe 91 does not interfere with the work of hanging the workpiece A on the cooling rollers 52. This can improve the workability of hanging the workpiece A on the cooling rollers 52.

As illustrated in FIGS. 2 and 3, in the cooling unit 50, the guide rollers 55a to 55g that set the conveyance route for the workpiece A are supported by the above-mentioned pair of support plates 53 and 54, a pair of support plates 57a and 57b, and a pair of support plates 58a and 58b. The pair of support plates 57a and 57b is provided on the loading section 50b side of the cooling unit 50. The support plates 57a and 57b are substantially at the same height as the loading section 50b and the unloading section 50c. The support plates 58a and 58b in a pair are provided to be opposed to each other on the unloading section 50c side of the cooling unit 50. The support plates 58a and 58b are substantially at the same height as the support plates 53 and 54, respectively. Each of the support plates 57a and 58a is provided substantially on the same plane as the support plate 53. Each of the support plates 57b and 58b is provided substantially on the same plane as the support plate 53.

The guide roller 55a is supported by the pair of support plates 57a and 57b. The guide roller 55b is supported by a connecting plate 57a1 joining the support plate 53 to the support plate 57a, and a connecting plate 57b1 joining the support plate 54 to the support plate 57b. The guide rollers 55c and 55d are supported by the pair of support plates 53 and 54. The guide rollers 55e to 55g are supported by the pair of support plates 58a and 58b. The right-side support plates 53, 57a and 58a have adjusting members 53f, 57c, and 58c for adjusting the horizontality of the guide rollers 55, respectively. The support form of the guide rollers 55 is not limited to such a form.

The adjacent support plates (here, support plate 53 and support plate 57a, support plate 53 and support plate 58a, support plate 54 and support plate 57b, and support plate 54 and support plate 58b) may be joined together by a detachable frame 59. The strength of the support plates may be improved by joining the adjacent support plates together through the frame 59. The frame 59 may be removed, for example, when replacing the cooling roller 52. The support plates 54 and 57a may be connected to the detachable frame 59.

The above is a detailed description of the technology disclosed herein through the specific embodiments, but those are illustrative only and do not limit the scope of the claims. Accordingly, the technology described in claims includes various variations and modifications of the embodiments described above.

The present specification includes the following Items 1 to 9. The following Items 1 to 9 are not limited to the above embodiments.

### Item 1

A cooling device including:
a loading section that loads a strip-shaped workpiece;
an unloading section that unloads the workpiece;
a plurality of cooling rollers; and
a pair of support plates that supports the plurality of cooling rollers, wherein
the cooling rollers are arranged in a staggered manner while being aligned with each other in an axial direction, with positions thereof sequentially displaced along a height direction,
the support plates in the pair are opposed to each other to sandwich a space in which the cooling rollers are arranged in the staggered manner, the support plates including bearings that support respective roller shafts of the plurality of cooling rollers, and
a conveyance route for the workpiece is set such that the workpiece is loaded from the loading section and sequentially hung along the height direction around the cooling rollers so as to bring a first surface of the workpiece into contact with a cooling roller displaced toward a first side and bring a second surface of the workpiece into contact with a cooling roller displaced toward a second side, among the plurality of cooling rollers, and then unloaded from the unloading section.

### Item 2

The cooling device according to Item 1, wherein at least one of the pair of support plates is provided with a through hole.

### Item 3

The cooling device according to Item 2, wherein the through hole is formed at a position overlapping the conveyance route for the workpiece in a direction in which the support plates in the pair are opposed to each other.

### Item 4

The cooling device according to Item 2 or 3, wherein the through hole is provided at a center portion of the support plate.

### Item 5

The cooling device according to any one of Items 2 to 4, wherein
one of the pair of support plates is provided with the through hole, and
the other support plate is provided with a refrigerant pipe through which a refrigerant is supplied to the cooling roller.

### Item 6

The cooling device according to any one of Items 1 to 5, wherein each of the pair of support plates includes support portions that support the plurality of cooling rollers, at a side surface of the support plate on the first side and a side surface of the support plate on the second side.

### Item 7

The cooling device according to Item 6, wherein each of the support portions protrudes from a corresponding one of the side surface on the first side and the side surface on the second side, of each of the pair of support plates.

### Item 8

The cooling device according to Item 6 or 7, wherein
the support plate has a second through hole formed in proximity to a position where the support portion is provided, and
the support portion is attached to the support plate by an attachment member that penetrates from an inner circumferential surface of the second through hole toward a closer one of the side surface on the first side and the side surface on the second side.

### Item 9

A heat treatment apparatus, including:
a heat treatment unit that performs heat treatment on the workpiece; and
the cooling device according to any one of Items 1 to 8 that cools the heat-treated workpiece.

What is claimed is:

1. A cooling device, comprising:
a loading section that loads a strip-shaped workpiece;
an unloading section that unloads the workpiece;
a plurality of cooling rollers; and
a pair of support plates that supports the plurality of cooling rollers, wherein
the cooling rollers are arranged in a staggered manner while being aligned with each other in an axial direction, with positions thereof sequentially displaced along a height direction,
the support plates in the pair are opposed to each other to sandwich a space in which the cooling rollers are arranged in the staggered manner, the support plates including bearings that support respective roller shafts of the plurality of cooling rollers, and
a conveyance route for the workpiece is set such that the workpiece is loaded from the loading section and sequentially hung along the height direction around the cooling rollers so as to bring a first surface of the workpiece into contact with a cooling roller displaced toward a first side and bring a second surface of the workpiece into contact with a cooling roller displaced toward a second side, among the plurality of cooling rollers, and then unloaded from the unloading section.

2. The cooling device according to claim 1, wherein at least one of the pair of support plates is provided with a through hole.

3. The cooling device according to claim 2, wherein the through hole is formed at a position overlapping the conveyance route for the workpiece in a direction in which the support plates in the pair are opposed to each other.

4. The cooling device according to claim 2, wherein the through hole is provided at a center portion of the support plate.

5. The cooling device according to claim 2, wherein
one of the pair of support plates is provided with the through hole, and
the other support plate is provided with a refrigerant pipe through which a refrigerant is supplied to the cooling roller.

6. The cooling device according to claim 1, wherein each of the pair of support plates includes support portions that support the plurality of cooling rollers, at a side surface of the support plate on the first side and a side surface of the support plate on the second side.

7. The cooling device according to claim 6, wherein each of the support portions protrudes from a corresponding one of the side surface on the first side and the side surface on the second side, of each of the pair of support plates.

8. The cooling device according to claim 6, wherein
the support plate has a second through hole formed in proximity to a position where the support portion is provided, and
the support portion is attached to the support plate by an attachment member that penetrates from an inner circumferential surface of the second through hole toward a closer one of the side surface on the first side and the side surface on the second side.

9. A heat treatment apparatus comprising:
a heat treatment unit that performs heat treatment on the workpiece; and
the cooling device according to claim 1 that cools the heat-treated workpiece.
